(19) United States
(12) Patent Application Publication
(10) Pub. No.: US 2026/0275537 A1
(43) Pub. Date: Sep. 17, 2026

(54) CATALYSTS FOR ELECTROCATALYTICALLY CONVERTING CARBON DIOXIDE TO FORMATE

(71) Applicant: The Trustees of Indiana University, Bloomington, IN (US)

(72) Inventors: Liang-Shi Li, Bloomington, IN (US); Minyang Yin, Columbus, OH (US)

(21) Appl. No.: 19/168,078

(22) PCT Filed: Mar. 22, 2024
(86) PCT No.: PCT/US2024/021123

§ 371 Date: Sep. 23, 2025

Related U.S. Application Data
(60) Provisional application No. 63/492,015, filed on Mar. 24, 2023.

(51) Int. Cl. C25B 3/07; C25B 3/26; C25B 11/085

(52) U.S. Cl. CPC C25B 3/07; C25B 3/26; C25B 11/085

(57) ABSTRACT

Methods and catalysts for electrocatalytically converting carbon dioxide to formate, which may then be used to produce formic acid. The catalyst is a mononuclear M(diimine)(CO)₂XY complex (where M is Mo or W, and X and Y are CO or X and Y are Cl and η³-CH₂C(CH₃)CH₂) of diimine ligands that contain a pyrazinyl moiety. A method of converting carbon dioxide to formate includes forming a mixture of the catalyst, water, and carbon dioxide, and electrocatalyzing the mixture to reduce the carbon dioxide to formate.

### CROSS-REFERENCE TO RELATED APPLICATIONS

This application claims the benefit of U.S. Provisional Application No. 63/492,015 filed Mar. 24, 2023, the contents of which are incorporated herein by reference.

### STATEMENT REGARDING FEDERALLY SPONSORED RESEARCH

This invention was made with government support under award #NSF CHE-1764264, awarded by the National Science Foundation. The government has certain rights in the invention.

### BACKGROUND OF THE INVENTION

The invention generally relates to catalysts and methods capable of electrocatalytically converting carbon dioxide (CO₂) to formate (HCO₂⁻ or HCOO⁻), and optionally to produce formic acid (HCOOH).

Man-made carbon dioxide (CO₂) has been changing the world climate and there is a need to recycle CO₂ into fuels or other useful chemicals. Formic acid is an important industrial chemical and has been proposed as a fuel as well. The change with CO₂ recycling has been energy efficiency (i.e., how much electrical energy is need), selectivity (i.e., what product(s) will be produced), cost, durability of the catalysts, etc.

Global climate change caused by CO₂ emission from burning fossil fuels poses significant challenges. Using renewable energy such as electricity or sunlight to drive conversion of CO₂ to fuels and other value-added materials is an attractive approach because it can not only decrease atmospheric CO₂ but also store energy in the resulting products. Due to their high energy densities and ease of storage and distribution, liquid products such as formic acid, methanol, ethanol, and others are especially desirable. Formic acid, in particular, has been proposed as an energy carrier in fuel cell applications and as a hydrogen storage material. In fact, recent techno-economic analyses show that formic acid may be the only economically viable liquid product.

Currently there is a need for catalysts, preferably made of earth-abundant elements, capable of reducing CO₂ to formate with high selectivity, low overpotential, and high stability. Nanoparticles or clusters based on tin, bismuth, and iron, etc., have been intensively studied as electrocatalysts for this purpose. In contrast, few mononuclear metal complexes can produce formic acid or formate with high selectivity. With large varieties of ligands that can be employed, metal complexes have the advantage of greater tunability in structures and catalytic activity.

Even though the group 6 metals molybdenum (Mo) and tungsten (W) have been found at active sites in many naturally occurring enzymes such as formate dehydrogenase (FDH) that catalyze the reversible conversion between CO₂ and formate, electrocatalytic CO₂ reduction with complexes of the group 6 metals have seldom been studied. It has been shown that M(bpy)(CO)₄ (M=Mo, W; bpy=2,2′-bipyridine) can electrocatalyze CO₂ reduction selectively to CO at a glassy carbon electrode in acetonitrile. Clark et al., Electrocatalytic CO₂ Reduction by M(bpy-R)(CO)₄ (M=Mo, W; R=H, tBu) Complexes, Electrochemical, Spectroscopic, and Computational Studies and Comparison with Group 7 Catalysts, Chem. Sci. 2014, 5, p 1894-1900. However, no water or other Brønsted acids could be added to facilitate the overall reaction CO₂+2H⁺+2e→CO+H₂O, because the potential required with the catalysts was so negative that the Brønsted acids themselves could be reduced to produce H₂. It was further shown that a gold electrode could decrease the CO₂ reduction overpotential catalyzed by the same complexes by 600 mV. Tory et al., [M(CO)₄(2,2′-bipyridine)](M=Cr, Mo, W) Complexes as Efficient Catalysts for Electrochemical Reduction of CO₂ at a Gold Electrode, ChemElectroChem 2015, 2, p 213-217. However, Brønsted acids still could not be introduced because gold decreases the overpotential for H₂ evolution as well.

In view of the above, there is an ongoing desire for methods capable of electrocatalytically reducing CO₂ to formate with high selectivity, and for catalysts for use in such methods.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, methods capable of electrocatalytically converting carbon dioxide to formate and to catalysts (electrocatalysts) capable of use in such methods.

According to a nonlimiting aspect of the invention, a method of converting CO₂ to formate includes forming a mixture of carbon dioxide, water, and a mononuclear M(diimine)(CO)₂XY complex (where M is Mo or W, and X and Y are CO or X and Y are Cl and η³-CH₂C(CH₃)CH₂) of diimine ligands that contain a pyrazinyl moiety, and electrocatalyzing the mixture to reduce the CO₂ to formate.

According to another nonlimiting aspect, a method of producing formic acid includes forming a mixture of carbon dioxide, water, and a mononuclear M(diimine)(CO)₂XY complex (where M is Mo or W, and X and Y are CO or X and Y are Cl and η³-CH₂C(CH₃)CH₂) of diimine ligands that contain a pyrazinyl moiety, electrocatalyzing the mixture to reduce the carbon dioxide to formate, and acidifying the formate to produce formic acid.

According to another nonlimiting aspect, a catalyst for electrocatalytically converting carbon dioxide to formate comprises a mononuclear M(diimine)(CO)₂XY complex (where M is Mo or W, and X and Y are CO or X and Y are Cl and η³-CH₂C(CH₃)CH₂) of diimine ligands that contain a pyrazinyl moiety.

Technical aspects of catalysts and methods as described above preferably include the ability to provide a mechanism for selectively reducing CO₂ to formate using an electrocatalyst and with water as a proton source. Formate thus produced can be optionally acidified to produce formic acid, which in turn may be utilized as an energy carrier in fuel cell applications and/or as a hydrogen storage material.

These and other aspects, arrangements, features, and/or technical effects will become apparent upon detailed inspection of the figures and the following description.

### BRIEF DESCRIPTION OF THE DRAWINGS

FIG. 1 is a schema representing metal (M) complexes that are suitable for use as catalysts for electrocatalytically reducing CO₂ to formate in accordance with non-limiting aspects of the invention. Two particular but non-limiting metal complexes are labeled as complex “1” and complex “3” in FIG. 1.

FIG. 2 is a schema illustrating two molybdenum (Mo) complexes that were evaluated as catalysts for electrocatalytically reducing CO₂ to formate in accordance with certain non-limiting aspects of the invention. The complex labeled as complex “1” in FIG. 2 corresponds to complex 1 of FIG. 1 in which Mo is the metal and X and Y are CO. The second complex depicted in FIG. 2 is labeled as complex “2” in which Mo is again the metal and X and Y are again CO.

FIGS. 3A and 3B are graphs showing data from cyclic voltammetry (CV) measurements of solutions containing the complex 1 (where M=Mo) of FIG. 2 in tetrahydrofuran (THF). FIG. 3A shows CV under argon (dot-dash curve), CO₂ (square-marked solid curve), and CO₂ and water (2% and 5% v./v., dotted curve and circle-marked solid curve, respectively). The rising current starting at around −2.3 V with water added was due to proton-coupled reduction. The inset in FIG. 3A is an enlargement of a selected voltage range. FIG. 3B shows CV scans with various concentrations of phenol added under an argon atmosphere.

FIGS. 4A to 4C are graphs showing data from infrared (IR) transmittance spectra of complex 1 (M=Mo) in THF under increasingly negative electrochemical potential (in the order of solid, square-marked, circle-marked, and triangle-marked curves). FIG. 4A shows data under argon. FIG. 4B shows data of complex 1 (M=Mo) under argon with phenol added. FIG. 4C shows data of complex 1 under CO₂ with H₂O added. In each of FIGS. 4A through 4C, the unmarked solid curves are spectra of initial 1. The inset in FIG. 4C shows the 1500-1800 cm⁻¹ range of the spectra. The peaks of species formed with protons present are marked by arrows.

FIG. 5 is a graph of data from CV measurements of a solution containing complex 2 in THF under argon (unmarked solid curve), CO₂ (square-marked solid curve), and CO₂ and water (5% v./v., circle-marked solid curve). For comparison, a CV curve for complex 1 of FIG. 2 in THF with CO₂ and 5% water (v./v., dotted curve) is also shown.

FIG. 6 is a schema illustrating a calculated pathway to metal hydrides in an exemplary Mo complex in accordance with certain non-limiting aspects of the invention.

FIG. 7 illustrates a comparison between a reduction method reported herein (lefthand side) and prior art reduction methods (righthand side).

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of the embodiment(s). The following detailed description also describes certain investigations relating to the embodiment(s), and identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter that at least provisionally is regarded to be aspects of the invention, including certain but not necessarily all of the aspects and alternatives described in the detailed description.

The present application is generally directed to catalysts made of earth abundant elements that can be used to promote carbon dioxide (CO₂)-to-formate conversion, and associated methods of performing such a conversion. A family of catalysts is disclosed that can electrochemically convert carbon dioxide (CO₂) to formate (HCO₂⁻ or HCOO⁻), which can be acidified to produce formic acid (HCOOH) that may then be utilized, as nonlimiting examples, as an energy carrier in fuel cell applications, a hydrogen storage material and other liquid fuels or chemical stock. With the application of electricity, the catalysts can convert CO₂ to formic acid with high yields, such as an approximately 98% yield.

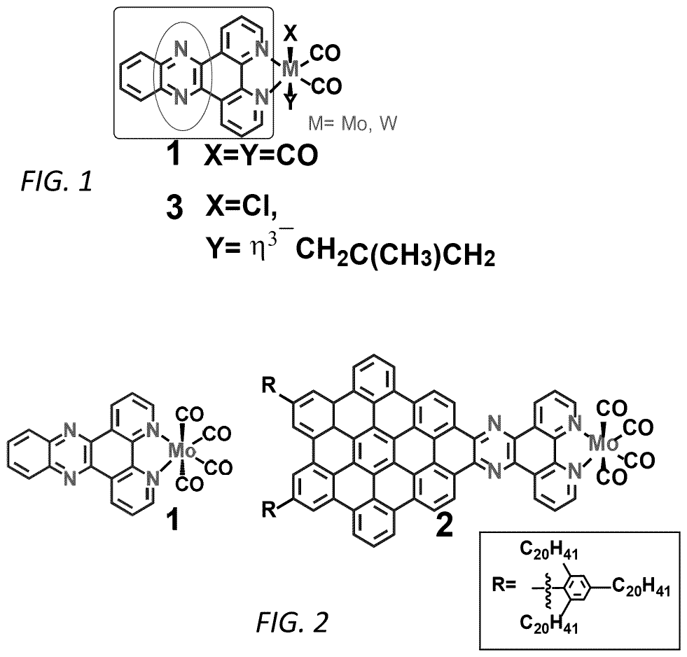

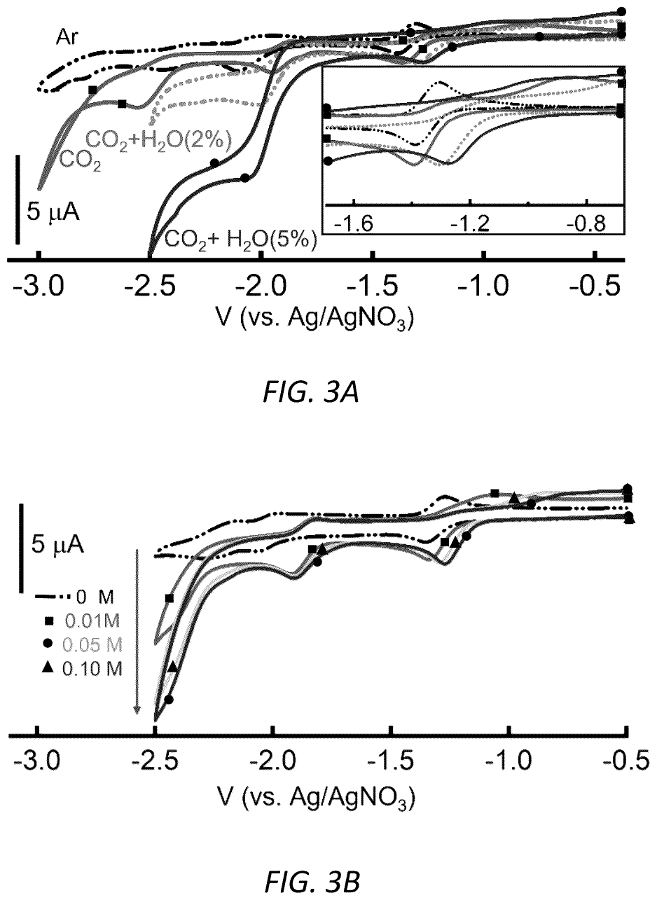

FIG. 1 is a schema representing metal (M) complexes of diimine ligands containing a pyrazinyl moiety that investigations leading to the present invention determined to be suitable for use as catalysts for electrocatalytically reducing CO₂ to formate based on electrochemical data presented in FIGS. 3A through 5. Two particular but non-limiting metal complexes are labeled as complex “1” and complex “3” in FIG. 1. The metal (M) is identified in FIG. 1 as molybdenum (Mo) or tungsten (W), and X and Y are CO or X and Y are Cl and η³-CH₂C(CH₃)CH₂). FIG. 2 is a schema illustrating two particular Mo complexes that were evaluated as described in the following discussion of the investigations. The complex labeled as complex “1” in FIG. 2 corresponds to complex 1 of FIG. 1 wherein Mo was the metal. The second complex depicted in FIG. 2 is labeled as complex “2” wherein Mo was again the metal. Investigations leading to the present invention further evaluated the complex 1 and complex 3 catalysts (M=Mo or W) of FIG. 1 with results determined to be so similar to the electrochemical data obtained for complexes 1 and 2 of FIG. 2 reported herein that conclusions drawn from the investigations of complexes 1 and 2 were concluded to be equally applicable to complex 3. As such, catalysts capable of converting carbon dioxide to formate using methods as described below can be described as mononuclear M(diimine)(CO)₂XY complexes (where M is Mo or W, and X and Y are CO or X and Y are Cl and η³-CH₂C(CH₃)CH₂) of diimine ligands that contain a pyrazinyl moiety.

The investigations evaluated catalysts having a ligand design that was shown to reduce CO₂ to formate with high selectivity and low overpotential with water as the proton source at glassy carbon electrodes. As noted above, the investigations specifically employed the mononuclear Mo-complexes represented as complex 1 and complex 2 in FIGS. 1 and 2 (the following discussion of the investigations will refer to these catalysts as complex 1 and complex 2, respectively, and sometimes collectively refer to these catalysts as the complexes), which are metal complexes of diimine ligands that contain a pyrazinyl moiety (enclosed in an oval frame in FIG. 1). Applying nanographenes as large conjugated diimine ligands was shown to significantly decrease the overpotential of CO₂ reduction. For example, replacing the bpy infac-[Re(bpy)(CO)3Cl] with a nanographene ligand as that in complex 2 led to highly selective reduction of CO₂ to CO and decreased the reduction overpotential by nearly 1 V. Subsequent mechanistic studies revealed the important roles played by the conjugated pyrazinyl moiety in improving the CO₂ reduction overpotential. The pyrazinyl nitrogen enabled a proton-coupled first reduction of the complexes, yielding a neutral radical species and making the second reduction occur much more readily to initiate the catalytic reactions. By increasing conjugation size of the diimine ligands, a faradaic efficiency of 93 (±5) % with an overpotential of 0.2 V can be achieved.

Electrochemical properties of complex 1 with a dipyrido[3,2-a:2′,3′-c]phenazine (dppz) ligand was studied with cyclic voltammetry (CV) in tetrahydrofuran (THF), data from which are shown in FIGS. 3A and 3B. The CV measurements were conducted with a glassy carbon working electrode, a platinum auxiliary electrode, and an Ag/AgNO₃ (0.01 M in acetonitrile) reference electrode. The solvent used was anhydrous THF freshly distilled over sodium metal, and a 0.10 M solution of freshly recrystallized tetrabutylammonium hexafluorophosphate (TBAPF6) was the supporting electrolyte.

The dot-dash curve in FIG. 3A shows the CV curve of complex 1 (scan rate: 100 mV/s) under an argon atmosphere (1 atm). The cathodic scan reveals two distinct reduction peaks, at −1.38 V and −2.10 V, respectively. Measurements with various scan rates revealed that the first reduction was quasi-reversible, consistent with previous work on Mo(bpy)(CO)₄ in that the first reduction was ligand-centered and chemically reversible, whereas the second reduction is clearly irreversible. The two reduction peaks appear at significantly less negative potentials than those for Mo(bpy)(CO)₄ under the same conditions (−2.07 V and −2.73 V, respectively), because of the larger conjugation of the diamine ligand in 1 and the electron-withdrawing pyrazinyl moiety.

When CO₂ (1 atm) was introduced into the solution, the first reduction occurred at the same potential, whereas there was an apparent shift of the second reduction peak to a less negative potential −1.98V (squared-marked curve, FIG. 3A). However, both reductions are now irreversible, with peak current doubled from those in Ar. There appears to be a third reduction with the peak position at −2.52 V with comparable current.

Drastic changes occurred when water was added under the CO₂ atmosphere. With increasing water content (2% and 5% vol./vol., dotted curve and circle-marked solid curve, FIG. 3A), the first reduction peak position gradually shifted to less negative potentials, while the step remained irreversible with peak current remaining twice that of the first reduction in Ar. Further, at a more negative potential, a substantially enhanced current was observed, indicating catalytic reduction of CO₂. The catalytic current increased with increasing water content. The CO₂ reduction onset potential was −1.80 V, about 500 mV less negative than that for Mo(bpy)(CO)₄ and 200 mV less negative than that for Re(bpy)(CO)₃Cl in THF. With foot-of-wave analysis, the maximum turnover frequency was obtained of complex 1 to be 2.63 s⁻¹ with 2% of water added and 5.72 s⁻¹ with 5% of water. The amount of water that could be added in the present experiments was limited by solubility of the complex in THF/water mixtures.

The reduction products were determined with bulk electrolysis at a glassy carbon mesh at the electrode at a potential of −1.90 V. The solution was analyzed with nuclear magnetic resonance (NMR) and the gas in the head space by gas chromatography. Formate was found to be the major product with a faradaic efficiency (FE) of 50 (±10)%, H₂ as the minor product with an FE of 46 (±9) %, and no CO was detected. The turnover number was found to be 39 over a 4-hour duration, which was not limited by degradation of the catalyst but limited by depletion of CO₂ in the experimental setup and thus was an underestimate. Of the H₂ produced, about half was due to proton reduction at the electrode, which as shown below can be suppressed by decreasing the overpotential for CO₂ reduction.

Absence of CO detected in the reaction products indicated that the catalytic mechanism was different from that with Re(diimines) systems and with Mo(bpy)(CO)₄. The surprisingly high FE for formate formation and no CO being produced suggested that the catalysis proceeds through a metal-hydride intermediate, which transfers a hydride to CO₂ and reduces it to formate. To support such a mechanism, studies were conducted by employing phenol as a proton source in place of CO₂ and water because [H⁺] for the latter is difficult to assess. Phenol under argon (Ar) (FIG. 3B) reproduced the first reduction of 1 observed with CO₂ and water (FIG. 3A). Increasing phenol concentration up to 0.10 M reproduced not only the magnitude of the potential shift but also doubled the peak current and loss of its reversibility. Thus, the first reduction of 1 with a proton source was attributed to a proton-coupled reduction followed by another one-electron reduction at the same potential. [H⁺] was estimated to be 10⁻¹⁴M with CO₂ and 5% water in THF, which is the value for 0.10 M phenol in THF (pKₐ=27.8). The current doubling of the first reduction under CO₂ without water (square-marked curve in FIG. 3A) was attributed to CO₂-adduct formation at the pyrazinyl N upon reduction. This was supported by CV of dibenzo[a,c]phenazine, a dppz analogue.

To investigate the roles played by the proton in the catalysis, infrared spectroelectrochemistry (IR-SEC) measurements were conducted. IR-SEC studies were conducted with an air-tight, transmission-mode thin-layer electrochemical (OTTLE) cell equipped with a pair of CaF₂ windows. In the cell, the working electrode was made of a Pt wire mesh. Another Pt wire mesh was used as the counter electrode and an Ag wire as a pseudo-reference electrode. Solvent and supporting electrolyte were the same as those used for the CV measurements, and all solutions were prepared and loaded to the cell under dry nitrogen in a glovebox. In the experiments the potential was made increasingly negative with a step size of −50 mV and held for 30 minutes for multiple spectra to be measured.

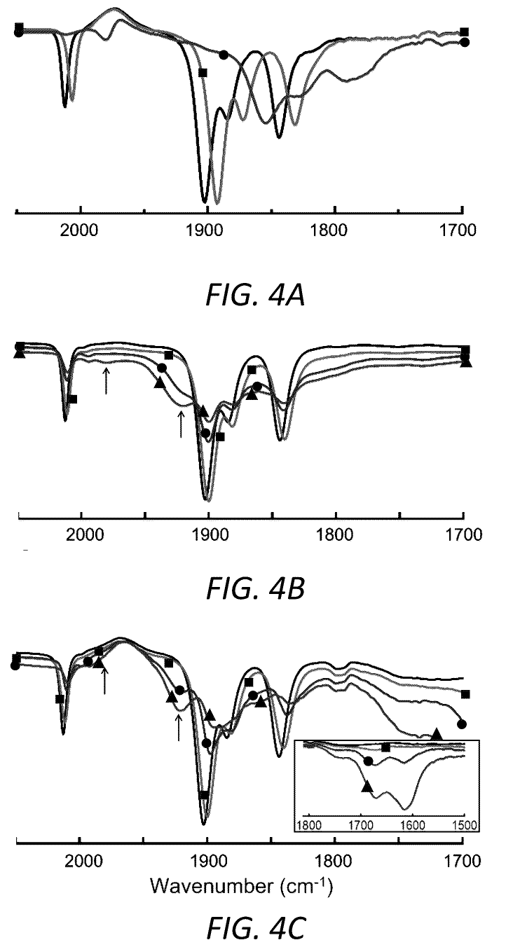

Shown in FIGS. 4A to 4C are evolution of transmission spectra under various conditions over a potential range of 800 mV, starting from an initial potential that was negative enough to produce spectral changes. FIG. 4A shows the CO stretching frequencies of complexes 1, 1⁻ and 1²⁻ that formed sequentially upon electrochemical reduction under Ar (solid, square-marked solid, and circle-marked solid curves, respectively). The species all show four peaks, which in the decreasing order of energy can be assigned to A₁, A₁, B₁, B₂ modes (in C₂ᵥ symmetry of complex 1), respectively. Because of electron density added to the π* orbitals of the CO ligands, the stretching frequencies shift from 2012, 1902, 1884, 1843 cm⁻¹ in complex 1 to 2006, 1892, 1872, 1831 cm⁻¹ in complex 1⁻ and then to 1979, 1855, 1826, 1786 cm⁻¹ in complex 1²⁻. Reduction of 1 to 1⁻, due to the pyrazinyl moiety, led to smaller shifts than the bpy counterpart.

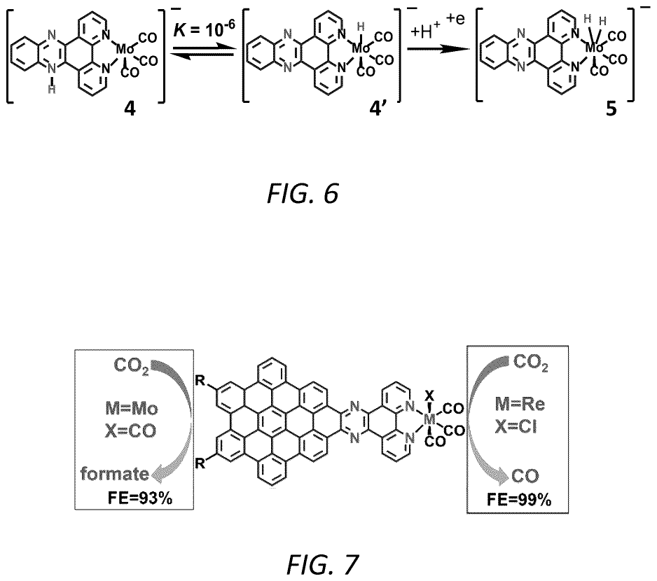

The presence of protons significantly modifies the reduction properties of complex 1, as shown in FIG. 4B (square-marked curve). The first reduction leads to much smaller shifts (to 2010, 1899, 1881, 1840 cm⁻¹, respectively) in the CO stretching frequencies than those observed in complex 1₋. This, by comparison with previous work on Re complexes, can be assigned to a protonated form of complex 1⁻ at a pyrazinyl N [Mo(dppzH)(CO)₄](1H), in which the proton withdraws electron density from the metal center and thus decreases the backbonding to COs. With an increasingly negative potential, a weak peak at 1994 cm⁻¹ was observed (circle-marked solid curve), which similarly can be assigned to a protonated form of complex 1²⁻ at a pyrazinyl N (1H⁻). Meanwhile a strong, broad peak at 1920 cm⁻¹ (marked by an arrow) started to develop, together with broad, featureless absorption over a range from 1830 to 1700 cm⁻¹. The large shifts in the CO stretching frequencies suggested a five-coordinate intermediate [Mo(dppzH)(CO)₃]⁻ (complex 4 in FIG. 6). The assignments are supported by quantum chemical DFT calculations. With a more negative potential applied, the peak at 1920 cm⁻¹ grew in intensity (triangle-marked solid curve), with an extra peak appearing at 1980 cm⁻¹ (marked by the second arrow). The 60 cm⁻¹ shift suggested the formation of a new six-coordinate complex.

The IR spectra in CO₂ and H₂O (FIG. 4C) shared all the spectral features observed with phenol under Ar (FIG. 4B), especially the two peaks at 1920 and 1980 cm⁻¹, respectively (marked by arrows), with addition of strong broad peaks in the 1500 to 1700 cm⁻¹ range corresponding to bicarbonate (1670 cm⁻¹) and formate (1606 cm⁻¹) (FIG. 4C, inset). The bicarbonate peak started to grow upon the first reduction (square-marked curve), possibly because the consumption of proton increased the concentration of carbonate formation. In contrast, growth of the formate correlates well with the 1920 and 1980 cm⁻¹ peaks (circle-marked solid curve and triangle-marked solid curve), indicating the importance of the species in CO₂ reduction. Significantly, the resemblance between the spectra shown in FIGS. 4B and 4C suggests that the intermediates formed with proton present were responsible for the CO₂ reduction, supporting a metal hydride-based reaction pathway.

Based on experimental results, a preliminary exploration was carried out of the possibility of metal-hydride formation with DFT calculations. As shown in FIG. 6, calculations showed that the five-coordinate 4 was in equilibrium with a six-coordinate metal hydride 4′ (ΔGO=+8.2 kcal/mol, K=10⁻⁶). Six-coordinate metal hydride 4′ can further undergo a proton-concerted reduction to form a dihydride 5 under the potential that is applied to produce six-coordinate metal hydride 4. The overall reaction 4→5 is thermodynamically favorable (ΔG°=−14.8 kcal/mol), assuming [H+]=10⁻¹⁴M in the reaction solution. Calculations showed that dihydride 4′ and 5 are able to donate a hydride to CO₂ to form formate. The calculated CO stretching frequencies for dihydride 5 were 1977, 1886, and 1838 cm⁻¹, the highest agreeing very well with the observed 1980 cm⁻¹. The two lower peaks, however, would overlap with absorption of other species present, and therefore could not be identified with high certainty. Repeating the IR-SEC experiments with deuterated phenol or D₂O did not lead to appreciable spectral changes. The calculated Mo—H stretching appeared at significantly lower frequencies, 1960 and 1840 cm⁻¹, with low oscillator strengths.

The amount of hydrogen produced at the glassy carbon electrode can be decreased by making the CO₂ reduction occur at a less negative potential. For this purpose, a nanographene was employed as the diimine, leading to complex 2. It was previously demonstrated that applying such a ligand in Re(diimine) complexes significantly decreases overpotential for reduction of CO₂ to CO. The R— groups are necessary to prevent x-stacking between the ligand and to make the complex soluble in organic solvents.

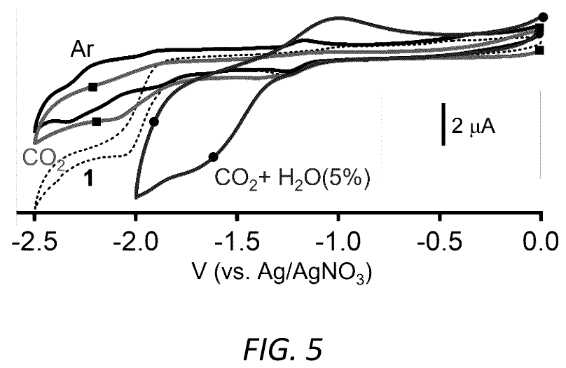

FIG. 5 presents CV results of complex 2 in THF under various conditions. The results qualitatively resemble those observed for complex 1 (FIGS. 4A and 4B), except that all reduction events occur at less negative potentials. Under CO₂ (1 atm) with water added (H₂O/THF 5/95 vol./vol.), a catalytic current appears starting at −1.30 V. In comparison with that of complex 1, complex 2 shows a further decrease in the CO₂ reduction overpotential by 400 mV. This led to an overpotential of approximately 0.2 V (using a calculated −1.30 V vs. Ag/AgNO₃ for the CO₂/HCOOH couple in THF as the equilibrium potential). Bulk electrolysis under the same conditions with the potential held at −1.60 V produced formate with an FE of 93 (±5) % and hydrogen with an FE of 6 (±4) %, again with no CO detected. Turnover number for formate was 29 over a four-hour duration. Using the same method, a TOFₘₐₓ of 16.9 s⁻¹ was obtained with 5% water. The value increased with water content as well (e.g., 21.5 s⁻¹ with 10% water), again limited by solubility of complex 2.

Recent efforts have seen ligands with pendant amines employed in mononuclear earth-abundant metal complexes, such as Co and Mn, as the secondary coordination spheres to improve the selectivity of CO₂ reduction to formate. Thus, it was surprising that complexes 1 and 2 with such simple structures can reduce CO₂ to formate with high selectivity.

The investigations reported above and further investigations with mononuclear W-complexes (also represented by complex 1 in FIG. 1) evidenced the ability of these metal complexes to catalyze highly selective conversion of CO₂ to formate with water as the proton source and glassy carbon as the electrode clearly was a practical advantage. The structural simplicity offers greater tunability, as shown herein, that larger conjugated diimine ligands can further decrease the CO₂ reduction overpotential and improve the faradaic efficiency. Further, because group 6 complexes are capable of absorbing visible light, the metal complexes described herein could serve as a new class of CO₂ photocatalysts without the need for additional sensitizers.

As previously noted above, though the foregoing detailed description describes certain aspects of one or more particular embodiments of the invention, alternatives could be adopted by one skilled in the art. As such, and again as was previously noted, it should be understood that the invention is not necessarily limited to any particular embodiment described herein or illustrated in the drawings.

1. A method of converting carbon dioxide to formate, the method comprising:
forming a mixture of carbon dioxide, water, and a mononuclear M(diimine)(CO)₂XY complex (where M is Mo or W, and X and Y are CO or X and Y are Cl and η³-CH₂C(CH₃)CH₂) of diimine ligands that contain a pyrazinyl moiety; and
electrocatalyzing the mixture to reduce the carbon dioxide to formate.

2. The method of claim 1, wherein the mononuclear M(diimine)(CO)₂XY complex has the schema

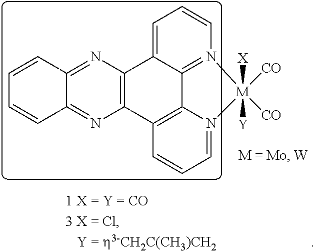

3. The method of claim 1, wherein the mononuclear M(diimine)(CO)₂XY complex is a mononuclear Mo(Diimine)(CO)₄ complex having the schema

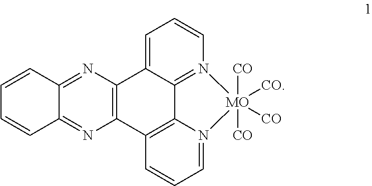

4. The method of claim 1, wherein the mononuclear M(diimine)(CO)₂XY complex is a mononuclear Mo(Diimine)(CO)₄ complex having the schema

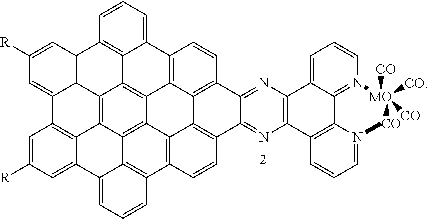

5. A method of producing formic acid, the method comprising:
forming a mixture of carbon dioxide, water, and a mononuclear M(diimine)(CO)₂XY complex (where M is Mo or W, and X and Y are CO or X and Y are Cl and η³-CH₂C(CH₃)CH₂) of diimine ligands that contain a pyrazinyl moiety;
electrocatalyzing the mixture to reduce the carbon dioxide to formate; and
acidifying the formate to produce formic acid.

6. The method of claim 5, wherein the mononuclear M(diimine)(CO)₂XY complex has the schema

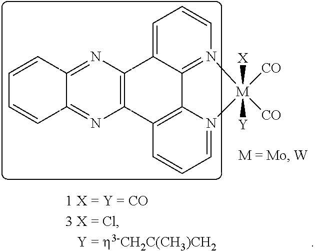

7. The method of claim 5, wherein the mononuclear M(diimine)(CO)₂XY complex is a mononuclear Mo(Diimine)(CO)₄ complex having the schema

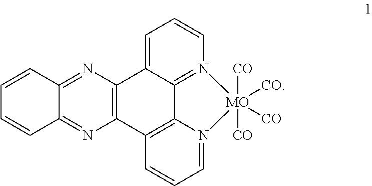

8. The method of claim 5, wherein the mononuclear M(diimine)(CO)₂XY complex is a mononuclear Mo(Diimine)(CO)₄ complex having the schema

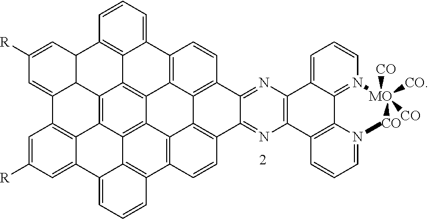

9. The method of claim 5, the method further comprising utilizing the formic acid as an energy carrier in a fuel cell application, or as a hydrogen storage material, or as a liquid fuel, or as a chemical stock.

10. A catalyst for electrocatalytically converting carbon dioxide to formate, the catalyst comprising a mononuclear M(diimine)(CO)₂XY complex (where M is Mo or W, and X and Y are CO or X and Y are Cl and η³-CH₂C(CH₃)CH₂) of diimine ligands that contain a pyrazinyl moiety.

11. The catalyst of claim 10, wherein the mononuclear M(diimine)(CO)₂XY complex has the schema

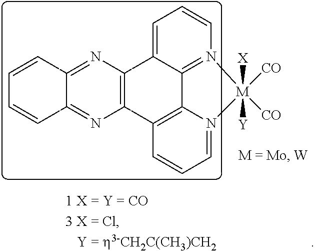

12. The catalyst of claim 10, wherein the mononuclear M(diimine)(CO)₂XY complex is a mononuclear Mo(Diimine)(CO)₄ complex having the schema

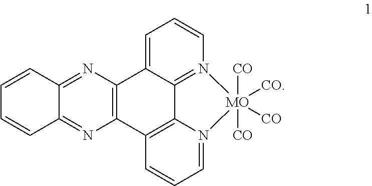

13. The catalyst of claim 10, wherein the mononuclear M(diimine)(CO)₂XY complex is a mononuclear Mo(Diimine)(CO)₄ complex having the schema [chemical structure]
